(19) United States
(12) Patent Application Publication
(10) Pub. No.: US 2018/0047350 A1
(43) Pub. Date: Feb. 15, 2018

(54) PIXEL RENDERING METHOD, PIXEL RENDERING DEVICE AND DISPLAY DEVICE

(71) Applicant: Wuhan China Star Optoelectronics Technology Co., Ltd., Wuhan, Hubei (CN)

(72) Inventors: Xingling GUO, Shenzhen, Guangdong (CN); Man LI, Shenzhen, Guangdong (CN); Zhenzhou XING, Shenzhen, Guangdong (CN)

(73) Assignee: Wuhan China Star Optoelectronics Technology Co., Ltd., Wuhan, Hubei (CN)

(21) Appl. No.: 14/916,991

(22) PCT Filed: Jan. 14, 2016
(86) PCT No.: PCT/CN2016/070911

§ 371 Date: Mar. 4, 2016

(30) Foreign Application Priority Data
Dec. 18, 2015 (CN) 201510964317.1

(51) Int. Cl. G09G 3/36; G09G 3/3225; G09G 5/04; G09G 3/20; G09F 9/30

(52) U.S. Cl. CPC G09G 3/3607; G09G 3/2003; G09F 9/301; G09G 5/04; G09G 3/2074; G09G 3/3225; G09G 2300/0452

(57) ABSTRACT

The present invention provides a pixel rendering method, including: obtaining gray scales of three primary color components of original image pixels; converting the gray scales of three primary color components of the original image pixels into three primary color components of compensation image pixels and gray scales of initial compensation components; sampling a compensation image, and extracting the former two primary color components of the former compensation image pixel and the third primary color component of the latter compensation image pixel in each set and grays scales of the compensation components; setting the former two primary color components of the former compensation image pixel and the third primary color component of the latter compensation image pixel in each set and the grays scales of the compensation components to be a gray scale of each corresponding sub pixel of each row of display pixels.

### CROSS REFERENCE

This application claims the priority of Chinese Patent Application No. 201510964317.1, entitled “Pixel rendering method, pixel rendering device and display device”, filed on Dec. 18, 2015, the disclosure of which is incorporated herein by reference in its entirety.

### FIELD OF THE INVENTION

The present invention relates to a display technology field, and more particularly to a pixel rendering method, a pixel rendering device and a display device.

### BACKGROUND OF THE INVENTION

The digital image generally comprises a plurality of image pixels, and each image pixel has limited, discrete color values. For example, these color values are gray scale values of the red component, the green component and the blue component in the (RGB, Red Green Blue) color space. The plurality of display pixels which are aligned in an array on the display are driven according to the digital image, and the digital image can be shown on the display.

As performing display according to the traditional sub pixel driving method, one sub pixel is employed for showing the value of one color component in the display image pixels. For raising the resolution of the display, more image pixels have to be shown. Namely, the amount of the sub pixels of the display screen has to be increased. However, due to the restriction of the manufacture process, after the sub pixel amount of the display screen reaches a certain level, it will be difficult to continue the increase. This causes that the resolution of the display is hard to be promote constantly.

Therefore, in prior art, it is common to show the digital image of high resolution on the display of low resolution, and the space resolution and the clarity of the shown digital image has to be ensured. For showing the digital image of high resolution on the display of low resolution, the method of Subpixel rendering (SPR) shown in FIG. 1 is utilized. The pixel rendering is a method to increase the expressing resolution of the liquid crystal display (LCD) or the organic light emitting diode display (OLED) by optimizing the screen physic property with pixel rendering. As shown in FIG. 1, the pixel rendering process method according to prior art is: as three pixels are compressed to one pixel. The sub pixel of one color is extracted respectively from the three pixels. For example: the single sub pixel is considered to be the smallest unit, and in case that they are repeated in order of RGB pixels, the 3j−1 green pixel of each row is considered to be the center for extraction, the pixel close to left is extracted with the R red pixel, and the pixel close to the right is extracted with the B blue pixel. Although such SPR arrangement can render High resolution image to be the low resolution image with high reduction degree, we can easily distinguish. The compression amount of the display pixels after the subpixel rendering is one-thirds of the original pixels. Such arrangement will dispose more supixels and image detail, and result in the appearance of the serious image blur phenomenon.

### SUMMARY OF THE INVENTION

The present invention relates to a pixel rendering method, a pixel rendering device, reducing the sub pixels and image detail disposed as pixel rendering to prevent the image blur.

The present invention further provides a display device.

The present invention provides a pixel rendering method, including: obtaining gray scales of three primary color components RGB of original image pixels RGBW; converting the gray scales of three primary color components of the original image pixels into three primary color components of compensation image pixels and gray scales of initial compensation components; sampling a compensation image, and each row of pixels of the compensation image comprises a plurality of pixel sets consisted of two adjacent compensation image pixels, and extracting the former two primary color components of the former compensation image pixel and the third primary color component of the latter compensation image pixel in each set and grays scales of the compensation components; setting the former two primary color components of the former compensation image pixel and the third primary color component of the latter compensation image pixel in each set and the grays scales of the compensation components to be a gray scale of each corresponding sub pixel of each row of display pixels.

The compensation components of the compensation image pixels are white color components.

A row resolution of an original image is twice of a row resolution of a display image.

In the step of converting the gray scales of three primary color components of the original image pixels into the three primary color components of the compensation image pixels and the gray scales of the initial compensation components, determining the gray scales of the compensation components according to a saturation of the original image pixels and a minimum of the grays scales of the three primary color components; calculating the gray scales of the three primary color components of the compensation image pixels according to a maximum of the grays scales of the three primary color components and the gray scales of the compensation components.

The present invention provides a pixel rendering device, comprising: an extracting unit, employed to obtain gray scales of three primary color components of original image pixels in RGBW color space; an converting unit, employed to convert the gray scales of three primary color components of the original image pixels into three primary color components of compensation image pixels and gray scales of compensation components; a sampling unit, employed to sample a compensation image, and each row of pixels of the compensation image comprises a plurality of pixel sets consisted of two adjacent compensation image pixels, and extract the former two primary color components of the former compensation image pixel and the third primary color component of the latter compensation image pixel in each set and grays scales of the compensation components; a multiplexing unit, employed to set the former two primary color components of the former compensation image pixel and the third primary color component of the latter compensation image pixel in each set and the grays scales of the compensation components to be a gray scale of each corresponding sub pixel of each row of display pixels.

The converting unit is further employed for: determining the gray scales of the compensation components according to a saturation of the original image pixels and a minimum of the grays scales of the three primary color components; calculating the gray scales of the three primary color components of the compensation image pixels according to a maximum of the grays scales of the three primary color components and the gray scales of the compensation components.

The compensation components of the compensation image pixels are white color components.

The present invention provides a display device, comprising the pixel rendering device; a display panel, having a plurality of rows of display pixels, and the display pixel comprises sub pixels of three primary colors and compensation sub pixels, and in each row of display pixels, the sub pixels of three primary colors and the compensation sub pixels are alternately aligned; a scan driving circuit, employed to circularly driving each row of display pixels; a data driving circuit, employed to receive gray scales of respective sub pixels of each row of display pixels from a pixel rendering device, and providing the same to corresponding sub pixels in the display pixels.

In the process of sampling the compensation image in the pixel rendering method of the present invention, it is to extract the former two primary color components of the former compensation image pixel and the third primary color component of the latter compensation image pixel in each set and grays scales of the compensation components, and then, in the following multiplexing process, it is to set the former two primary color components of the former compensation image pixel and the third primary color component of the latter compensation image pixel in each set and the grays scales of the compensation components to be a gray scale of each corresponding sub pixel of each row of display pixels. It primarily prevents from disposing too many sub pixels and image detail, and the disposed data amount is reduced from the previous two-thirds according to prior art to the half. Therefore, the appearance of the serious image blur phenomenon can be prevented.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a principle diagram of a sub pixel rendering method according to prior art.

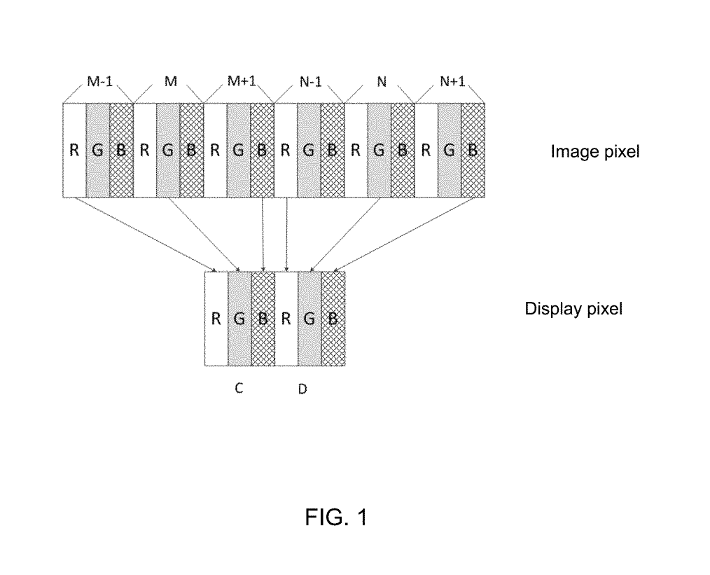

FIG. 2 is a flowchart diagram of a pixel rendering method of the present invention.

FIG. 3 is a principle diagram of pixel sampling and multiplexing according to the present invention.

FIG. 4 is a module diagram of a pixel rendering device of the present invention.

### DETAILED DESCRIPTION OF PREFERRED EMBODIMENTS

For better explaining the technical solution and the effect of the present invention, the present invention will be further described in detail with the accompanying drawings in the specific embodiments.

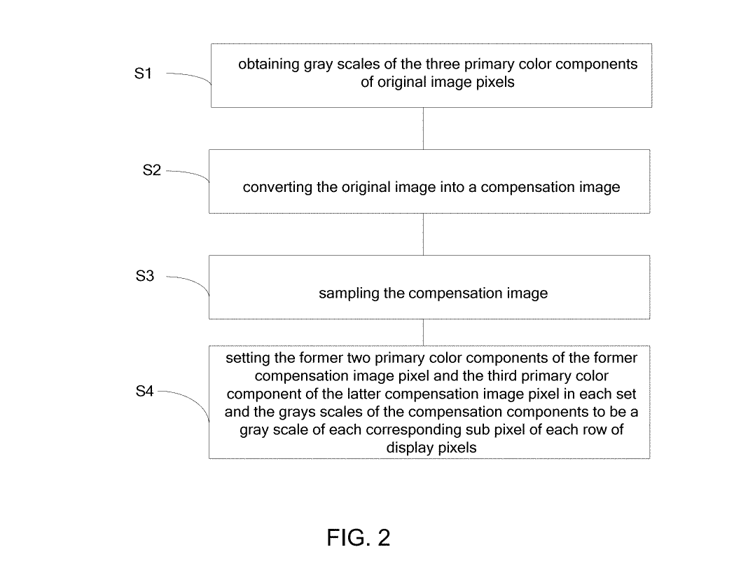

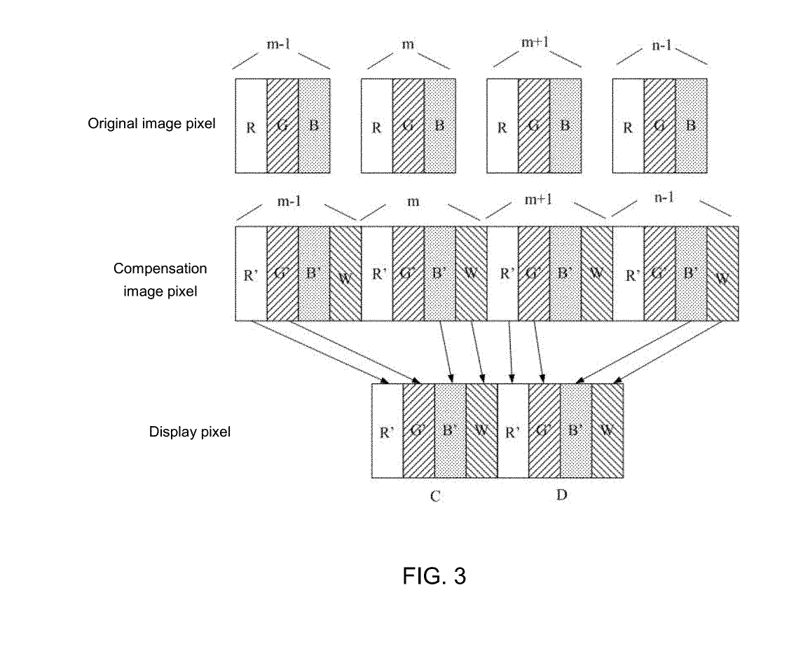

Please refer to FIG. 2 and FIG. 3. The preferred embodiment of the present invention provides a pixel rendering method, which mainly is employed to sample and multiplex the row of the pixels of high resolution original image to achieve the compression to the original image for being adapted with the physical resolution of the display. The method comprises:

step S1, providing an original image of high resolution, and obtaining gray scales of the three primary color components of original image pixels RGB.

The gray scales of the three primary color components means the gray scales of the red component (R), the green component (G) and the blue component (B). The illustration of FIG. 3 shows that in each row of the original image, four original image pixels M−1, M, M+1 and N−1 are continuously aligned, and each pixel represents the gray scales of three primary color components (R, G, B).

step 2, converting the original image into a compensation image. Specifically, converting the gray scales of three primary color components of the original image pixels (R, G, B) into three primary color components (R′, G′, B′) of compensation image pixels and gray scales of initial compensation components W. Generally, the transmission and the mixing efficiency of the display screen of the RGB mixture are lower, and the image brightness which is actually shown on the display is darker. In this step, the added compensation components of the compensation image pixels can improve the brightness of the display screen. The compensation component W can be the white component, the yellow component, the blue component or magenta component.

In this embodiment, the white component is illustrated for the compensation components W to explain the calculation process of respective components of the compensation image in this embodiment.

The maximum of the grays scales of the three primary color components (R, G, B) is indicated with Max (R, G, B), and the minimum is indicated with Min (R, G, B). The saturation of the original image pixels is represented:

S=[Max(R,G,B)−Min(R,G,B)]/Max(R,G,B) (1)

First, the gray scale of the compensation component is determined according to the saturation of the original image pixels and the gray scales of the three primary color components (R, G, B). The initial compensation component of the compensation image pixel is represented:

W=Min(R,G,B)*(1−S) (2)

Then, the gray scales of the three primary color components of the compensation image pixels are calculated: The three primary color components of the compensation image pixel are represented:

R′=[Max(R,G,B)+W]/Max(R,G,B)*R−W

G′=[Max(R,G,B)+W]/Max(R,G,B)*G−W (3)

B′=[Max(R,G,B)+W]/Max(R,G,B)*B−W

The red component is illustrated:

$$\begin{matrix}{R}^{′} = \frac{Max ( R , G , B ) + W}{Max ( R , G , B )} * R - W \\ = R + \frac{W}{Max ( R , G , B )} * R - W \\ = R + \frac{Min ( R , G , B ) * ( 1 - S )}{Max ( R , G , B )} * R - Min ( R , G , B ) * ( 1 - S ) \\ = R + Min ( R , G , B ) * ( 1 - S ) * \frac{R}{Max ( R , G , B )} - Min ( R , G , B ) * ( 1 - S ) \\ = R + Min ( R , G , B ) * ( 1 - S ) * [ \frac{R}{Max ( R , G , B )} - 1 ]\end{matrix}$$

Due to

$$\frac{R}{Max ( R , G , B )} - 1 < 0 ,$$

thus, R′<R. Similarly, it can be derived that G′<G, B′<B.

Thus, in comparison with the conversion from the RGB data to the RGBW data according to prior art, the aforesaid process in this embodiment can reduce the values of the three primary color components (R′, G′, B′) while reducing the values of the compensation components W to reduce the power consumption of the display panel altogether. Meanwhile, it can increase the three primary color components of the actual display image, and can compensate the display brightness descend due to the decreases of the three primary color component values, and can maintain the brightness of the display remained.

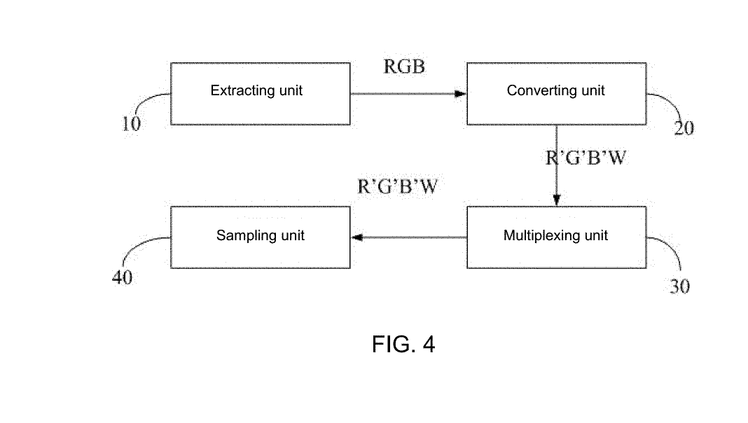

Please refer to FIG. 3 and FIG. 4, step S3, sampling the compensation image, and each row of pixels of the compensation image comprises a plurality of pixel sets consisted of two adjacent compensation image pixels, and extracting the former two primary color components (R′, G′) of the former compensation image pixel and the third primary color component B′ of the latter compensation image pixel in each set and grays scales of the compensation components W. In this embodiment, two sets, which respectively are M−1, M, M+1, N−1 are illustrated for explanation. The former two primary color components (R′, G′) of the compensation image pixel M−1 is extracted, and the latter two primary color components, which respectively are the primary color B′ and the compensation component W of the compensation image pixel M are extracted.

step 4, setting the former two primary color components of the former compensation image pixel and the third primary color component of the latter compensation image pixel in each set and the grays scales of the compensation components to be a gray scale of each corresponding sub pixel of each row of display pixels. Namely, the former two primary color components (R′, G′) of M−1, the primary color B′ of the compensation image pixel M and the compensation component W are multiplexed into the display pixel C to be one RGBW sub pixel. Similarly, the former two primary color components (R′, G′) of compensation image pixel M+1, and the primary color B′ of N−1 and the compensation component W are respectively loaded to the RGBW sub pixels of the display pixel D. Accordingly, the display data of the display image pixels C and D shown in FIG. 4 can be obtained.

In the process of sampling the compensation image as aforementioned, it is to extract the former two primary color components of the former compensation image pixel and the third primary color component of the latter compensation image pixel in each set and grays scales of the compensation components, and then, in the following multiplexing process, it is to set the former two primary color components of the former compensation image pixel and the third primary color component of the latter compensation image pixel in each set and the grays scales of the compensation components to be a gray scale of each corresponding sub pixel of each row of display pixels. It does not only well complete the multiplexing and rendering of the sub pixels but also primarily prevent from disposing too many sub pixels and image detail, and the disposed data amount is reduced from the previous two-thirds according to prior art to the half. Therefore, the appearance of the serious image blur phenomenon can be prevented, and the image process quality can be significantly promoted.

In this embodiment, a row resolution of an original image is twice of a row resolution of a display image.

Furthermore, in the step of converting the gray scales of three primary color components of the original image pixels into the three primary color components of the compensation image pixels and the gray scales of the initial compensation components, determining the gray scales of the compensation components according to a saturation of the original image pixels and a minimum of the grays scales of the three primary color components; calculating the gray scales of the three primary color components of the compensation image pixels according to a maximum of the grays scales of the three primary color components and the gray scales of the compensation components.

The present invention further provides a pixel rendering device, comprising:

an extracting unit 10, employed to obtain gray scales of three primary color components RGB of original image pixels in RGBW1 color space;

a converting unit 20, employed to convert the gray scales of three primary color components RGB of the original image pixels RGBW1 into three primary color components (R′, G′, B′) of compensation image pixels and gray scales of initial compensation components W;

a sampling unit 30, employed to sample a compensation image, and each row of pixels of the compensation image comprises a plurality of pixel sets consisted of two adjacent compensation image pixels, and extract the former two primary color components (R′, G′) of the former compensation image pixel and the third primary color component B′ of the latter compensation image pixel in each set and grays scales of the compensation components W;

a multiplexing unit 40, employed to set the former two primary color components of the former compensation image pixel and the third primary color component of the latter compensation image pixel in each set and the grays scales of the compensation components to be a gray scale of each corresponding sub pixel of each row of display pixels.

Furthermore, the converting unit 20 is further employed for: determining the gray scales of the compensation components according to a saturation of the original image pixels and a minimum of the grays scales of the three primary color components; calculating the gray scales of the three primary color components of the compensation image pixels according to a maximum of the grays scales of the three primary color components and the gray scales of the compensation components.

The present invention further provides a display device, comprising the pixel rendering device, a display panel, a scan driving circuit and a data driving circuit. The display panel has a plurality of rows of display pixels, and the display pixel comprises (R, G, B) sub pixels of three primary colors and compensation sub pixels W, and in each row of display pixels, the (R, G, B) sub pixels of three primary colors and the compensation sub pixels W are alternately aligned. The scan driving circuit is employed to circularly driving each row of display pixels. The data driving circuit is employed to receive gray scales of respective sub pixels of each row of display pixels from a pixel rendering device, and providing the same to corresponding sub pixels in the display pixels. The image after rendering is shown on the display panel.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A pixel rendering method, comprising:
obtaining gray scales of three primary color components RGB of original image pixels RGB;
converting the gray scales of three primary color components of the original image pixels into three primary color components of compensation image pixels and gray scales of initial compensation components;
sampling a compensation image, and each row of pixels of the compensation image comprises a plurality of pixel sets consisted of two adjacent compensation image pixels, and extracting the former two primary color components of the former compensation image pixel and the third primary color component of the latter compensation image pixel in each set and grays scales of the compensation components;
setting the former two primary color components of the former compensation image pixel and the third primary color component of the latter compensation image pixel in each set and the grays scales of the compensation components to be a gray scale of each corresponding sub pixel of each row of display pixels.

2. The pixel rendering method according to claim 1, wherein the compensation components of the compensation image pixels are white color components.

3. The pixel rendering method according to claim 2, wherein a row resolution of an original image is twice of a row resolution of a display image.

4. The pixel rendering method according to claim 3, wherein in the step of converting the gray scales of three primary color components of the original image pixels into the three primary color components of the compensation image pixels and the gray scales of the initial compensation components, determining the gray scales of the compensation components according to a saturation of the original image pixels and a minimum of the grays scales of the three primary color components; calculating the gray scales of the three primary color components of the compensation image pixels according to a maximum of the grays scales of the three primary color components and the gray scales of the compensation components.

5. A pixel rendering device, comprising:
an extracting unit, employed to obtain gray scales of three primary color components of original image pixels in RGB color space;
a converting unit, employed to convert the gray scales of three primary color components of the original image pixels into three primary color components of compensation image pixels and gray scales of compensation components;
a sampling unit, employed to sample a compensation image, and each row of pixels of the compensation image comprises a plurality of pixel sets consisted of two adjacent compensation image pixels, and extract the former two primary color components of the former compensation image pixel and the third primary color component of the latter compensation image pixel in each set and grays scales of the compensation components;
a multiplexing unit, employed to set the former two primary color components of the former compensation image pixel and the third primary color component of the latter compensation image pixel in each set and the grays scales of the compensation components to be a gray scale of each corresponding sub pixel of each row of display pixels.

6. The pixel rendering device according to claim 5, wherein the converting unit is further employed for: determining the gray scales of the compensation components according to a saturation of the original image pixels and a minimum of the grays scales of the three primary color components; calculating the gray scales of the three primary color components of the compensation image pixels according to a maximum of the grays scales of the three primary color components and the gray scales of the compensation components.

7. The pixel rendering device according to claim 5, wherein the compensation components of the compensation image pixels are white color components.

8. A display device, comprising: a display panel having a plurality of rows of display pixels, and the display pixel comprises sub pixels of three primary colors and compensation sub pixels, and in each row of display pixels, the sub pixels of three primary colors and the compensation sub pixels are alternately aligned;
a scan driving circuit, employed to circularly driving each row of display pixels;
a data driving circuit, employed to receive gray scales of respective sub pixels of each row of display pixels from a pixel rendering device, and providing the same to corresponding sub pixels in the display pixels;
the device further comprises the pixel rendering device, and the pixel rendering device further comprises an extracting unit, employed to obtain gray scales of three primary color components of original image pixels in RGB color space;
a converting unit, employed to convert the gray scales of three primary color components of the original image pixels into three primary color components of compensation image pixels and gray scales of compensation components;
a sampling unit, employed to sample a compensation image, and each row of pixels of the compensation image comprises a plurality of pixel sets consisted of two adjacent compensation image pixels, and extract the former two primary color components of the former compensation image pixel and the third primary color component of the latter compensation image pixel in each set and grays scales of the compensation components;
a multiplexing unit, employed to set the former two primary color components of the former compensation image pixel and the third primary color component of the latter compensation image pixel in each set and the grays scales of the compensation components to be a gray scale of each corresponding sub pixel of each row of display pixels.

9. The display device according to claim 8, wherein the converting unit is further employed for: determining the gray scales of the compensation components according to a saturation of the original image pixels and a minimum of the grays scales of the three primary color components; calculating the gray scales of the three primary color components of the compensation image pixels according to a maximum of the grays scales of the three primary color components and the gray scales of the compensation components.

10. The display device according to claim 8, wherein the compensation components of the compensation image pixels are white color components.
